(19) United States
(12) Patent Application Publication
(10) Pub. No.: US 2002/0114983 A1
(43) Pub. Date: Aug. 22, 2002

(54) Portable fuel cell electric power source

(75) Inventors: Kenneth M. Frank, Kearney, NE (US); Douglas A. Nichols, Kearney, NE (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Coleman Powermate, Inc.

(21) Appl. No.: 09/790,324

(22) Filed: Feb. 21, 2001

(51) Int. Cl. H01M 16/00; H01M 8/04

(52) U.S. Cl. 429/9; 429/22; 429/19; 220/577

(57) ABSTRACT

A portable fuel cell electric power generator is disclosed, suitable for use as a UPS (100), including a fuel cell assembly (200), a power conditioning system (160) including a DC to DC converter and a DC to AC inverter, a plurality of metal hydride canisters (300), a manifold assembly (320), and a battery system (150), all enclosed in a mobile chassis (130). The fuel cell assembly includes a compressor (230) for providing compressed air to the fuel cell stack (210) and a condenser for condensing water vapor generated by the fuel cell stack. The canisters provide hydrogen to the fuel cells, and can be hot swapped such that the generator can operate continuously for an indefinite period. The battery system provides start-up power to the compressor, as well as initial back up power for the power outlet during fuel cell start-up. A heat transfer device (307) in the canisters aids in maintaining the desired temperature in the metal hydride. An air flow system including a fan (24) and cowling (245) direct air over the fuel cell stack to remove excess heat, and past the canisters to warm the canisters.

### FIELD OF THE INVENTION

The present invention relates to power generators, and more particularly to portable electric power generators.

### BACKGROUND OF THE INVENTION

Electric power is ubiquitous in modern society, providing energy for many of the conveniences that have accompanied the industrial revolution. A major enabling factor supporting the growth of the national and world economy is the ready availability of a source of electric power. Moreover, the need for a reliable and continuous source of electricity is growing as the economy, both locally and internationally, becomes dependent on information and communications technology. In industrialized nations most of the electric power is distributed through an energy grid wherein electricity is generated in large power plants that are interconnected with each other and with the customers, or users, of the electricity. The centralized power plant model is remarkably efficient, permitting power generation plants to benefit from economies of scale and to select power generation equipment that is suited to the projected need and resources available.

A disadvantage of the centralized system is that the user is typically completely reliant on the central power generator and the stability of the power grid. The electric power grid is, however, subject to outages that may result from many different causes, such as natural disasters, human errors, over-demand, power plant maintenance requirements, and the like. When the power grid (or more precisely, a portion of the grid) goes down, it typically happens without warning. The impact of such outages can vary from inconvenience to life-threatening. The lack of warning can be particularly disadvantageous in computer-related applications, wherein a sudden loss of power can result in significant and unrecoverable losses of data, as well as damage to sensitive equipment.

Critical applications, such as hospitals, and nuclear power plant emergency systems, typically maintain secondary emergency power generators that are designed to come on line automatically when the local power grid goes down. Emergency power generators may comprise large banks of batteries and/or gas or diesel powered engines that drive electric generators. These types of emergency power generators are expensive, generate undesirable byproducts such as carbon monoxide and nitrous oxide, are complicated mechanical devices that are also subject to failure, and/or utilize hazardous materials such as lead, motor oil, oil filters and the like, that may present a health risk and are difficult to dispose of properly. A further disadvantage of battery-based emergency power systems is that the batteries have a relatively short useful life before they must be recharged.

Small gas-powered emergency power generators are available for individual users or other less-demanding applications. Examples of such independent power sources include Coleman Powermate's POWERSTATION line of generators. Battery-powered emergency power systems, often termed “uninterruptible power supplies” are also well-known in the art.

Additionally, the electric power grid is not available everywhere. The power grid is available in virtually all populated areas of the country in the United States. However, remote portions of the country are not wired into the grid. Moreover, in less developed nations, even populated regions may not have ready access to electricity.

Fuel cell electric power generators provide a direct energy conversion alternative to conventional electric power generators. In a typical fuel cell, a gaseous fuel is fed continuously to an anode and an oxidant is fed continuously to a cathode. An electrochemical reaction takes place at the electrodes to produce an electric current. Several different types of fuel cells are known, including polymer electrolyte fuel cells, alkaline fuel cells, phosphoric acid fuel cells, molten carbonate fuel cells and solid oxide fuel cells.

In a fuel cell utilizing hydrogen gas as the fuel, electricity is generated by the disassociation of a hydrogen atom's electron from its proton and the eventual combination of the proton and an electron with oxygen atoms to create pure water and heat. This electrochemical reaction may be usefully accomplished using a proton exchange membrane (PEM) electrolyte sandwiched between electrodes plated with a catalyst such as platinum. On either side of the PEM, hydrogen and oxygen are introduced next to the anode and cathode, respectively. Protons from disassociated hydrogen atoms at the anode migrate through the PEM to the oxygen-containing cathode side, thereby creating an electrical potential. The electrical potential induces a current through the circuit connecting the anode and cathode, as the free electron from the hydrogen travels from the anode to the cathode.

A fuel cell stack is a collection of individual fuel cells, each of which includes its own cathode, anode, and proton exchange membrane. The power output characteristics of a fuel cell depend on the particular fuel cell design. Stacking fuel cells permits the designer to achieve the total power output desired. Unlike batteries, which discharge over time, and must be recharged or replaced periodically, as long as a fuel cell has both oxygen and hydrogen, it will continue to generate electricity.

The advantages of fuel cell technology are several. A fuel cell utilizing hydrogen fuel generates electricity without combusting the hydrogen and creates no toxic exhaust. Therefore fuel cell generators are very environmentally friendly and can be used indoors. Fuel cells can be designed that operate at or near room temperature. Fuel cell generators have few moving parts and therefore they are very quiet and reliable. Fuel cell generator power output is stable and reliable as long as hydrogen and oxygen are supplied, and the power output is scaleable in a very straightforward manner.

The need exists for smaller scale, portable uninterruptible power systems that can operate relatively quietly without generating noxious fumes. The present invention meets this need by combining the advantages of fuel cell technology with the convenience of portability and the reliability of seamless power back-up.

### SUMMARY OF THE INVENTION

The present invention is directed to a portable fuel cell electric power generator suitable for use as an uninterruptible power supply. In a disclosed embodiment, the generator includes a fuel cell assembly including a fuel cell stack, an air compressor, a hydrogen gas regulator, and an electronic control module. The fuel cell assembly generates electricity from air (oxygen) and hydrogen without combustion. The generator also includes at least one canister containing a metal hydride for providing hydrogen to the regulator. A rechargeable battery pack is included to provide power during startup, and for surge power. A power conditioning system including a DC to DC converter and a DC to AC inverter receives the direct current from the fuel cell assembly and/or the battery pack and outputs the desired alternating current. The entire system is housed in a chassis adapted to transportably support the generator. The chassis provides mechanical structure and air stream baffling to produce the proper flow of air to the various components in the system. In one embodiment, a microprocessor based system controller manages the overall system operation and provides the automatic load transfer functions.

In an aspect of the invention, a cylindrical heat transfer device is provided in the canister to improve heat transfer into the metal hydride, which is a relatively poor conductor. The heat transfer device has a plurality of radially extending bristles that provide a heat conduction path through the metal hydride.

In another aspect of the invention, a cooling fan is provided to circulate air over the fuel cell stack to remove excess heat. At least a portion of the heated air is then directed toward the canisters, to help maintain the canister temperature.

In yet another aspect of the invention, multiple metal hydride canisters are connected to a manifold assembly that then directs the released hydrogen to the hydrogen gas regulator.

In another aspect of the invention, valves are provided in the manifold assembly and the metal hydride canisters such that the canisters can be hot swapped while the generator is running.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an perspective view of an embodiment of an uninterruptible power supply according to the present invention connected to a computer system;

FIG. 2 shows an exploded view of the uninterruptible power supply of FIG. 1;

FIG. 3 shows an exploded view of a metal hydride canister of the type shown in FIG. 2;

FIG. 4 shows a front view of the manifold assembly shown in FIG. 2, with the manifold cowling shown in phantom;

FIG. 5 shows a detail, partially cutaway view of the metal hydride canister connected to the valve actuator shown in FIG. 2;

### DETAILED DESCRIPTION OF THE PREFERRED EMBODIMENT

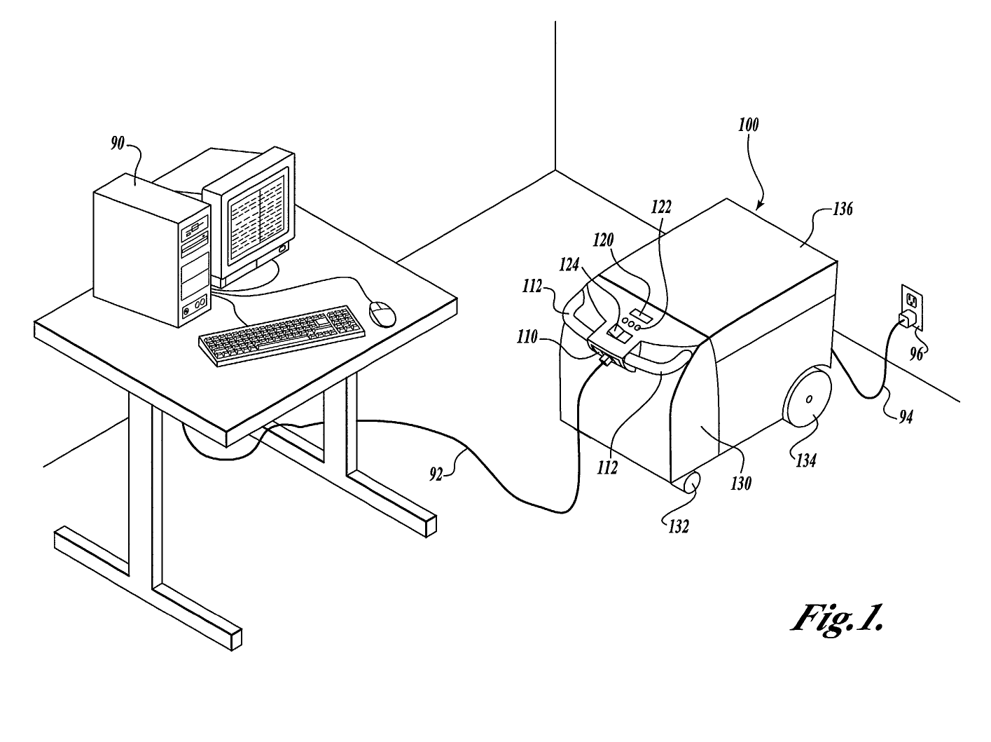

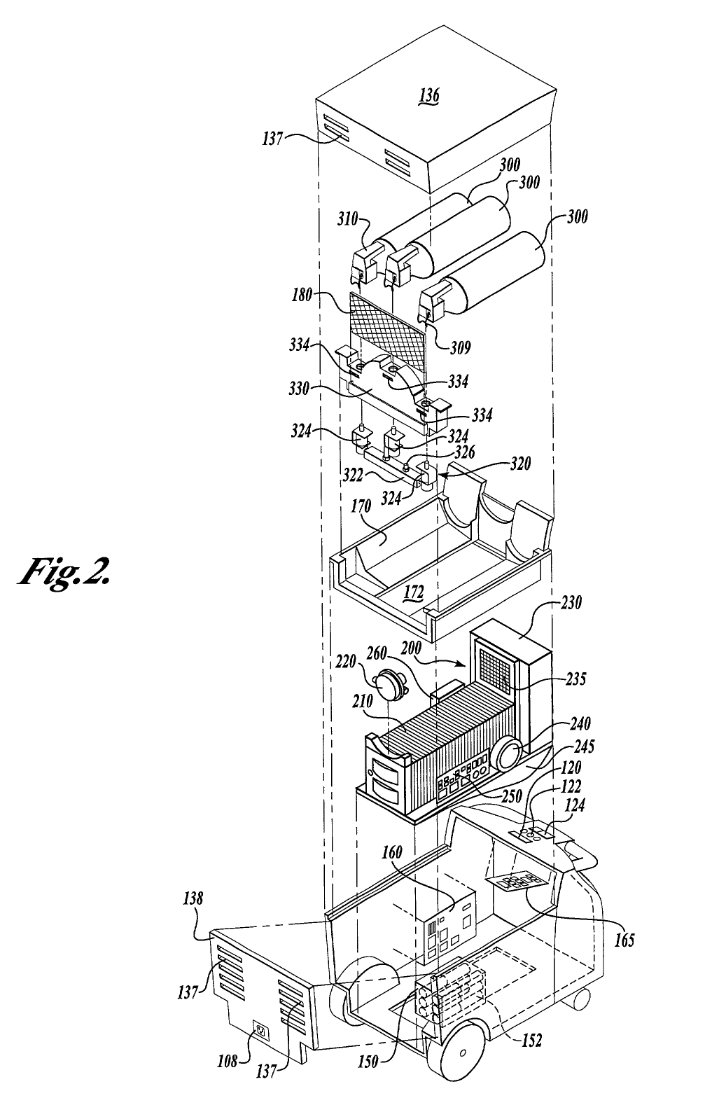

In a first embodiment of the present invention, depicted in FIG. 1, a transportable uninterruptible power supply (UPS) 100 is shown. The UPS 100 is connected to an external source of electrical power, such as a conventional wall outlet 96 through an input power cord 94 connected to input power receptacle 108 (FIG. 2). An output power receptacle 110 is located at the front of the UPS 100, and may include one or more individual receptacles. A power-consuming device, such as a computer 90, is connected to the output power receptacle 110 with a second power cord 92. As long as electrical power is provided to the UPS 100 through input power cord 94, the external power source 96 supplies the electrical energy that is ultimately output through the output power receptacle 110. In the preferred embodiment, a power conditioning system 160 (FIG. 2) conditions all of the electrical current output at the output power receptacle 110.

A multi-position mode switch 124 allows the user to activate, or deactivate the UPS 100 fuel cell power system. In the preferred embodiment the mode switch 124 can be set to one of two positions: 1) a “POWERCELL” position wherein the external power source 96 provides power to the output power receptacle 110 if such power is available, but if external power is not available or if it is interrupted during use, the fuel cell assembly 200 (discussed below) activates to provide power to the power output receptacle 110; and 2) a “LINEPOWER” position, wherein line power is passed through the on board power transfer circuitry to the output receptacle 110 from the external power source 96 as long as such power is available. As shown in FIG. 2, the UPS 100 also includes an on-board battery system 150. The battery system 150 includes a battery charger (not shown) that attempts to maintain the batteries 152 at full charge. Note that if the mode switch 124 is in the “POWERCELL” position, and the external power source 96 fails, the battery system 150 provides power through the UPS 100, and to the output power receptacle 110 while the fuel cell assembly 200 is powering up. With the mode switch 124 in the “POWERCELL” position, the UPS 100 can also be used, for example, as an independent power source in locations where an external power source 96 is not available. In this case, the power cord 94 is not used.

An alphanumeric display 120 and/or an indicator light display 122 notifies the user of the operational status of the UPS 100, and provides various warnings and other information. In the preferred embodiment an audio indicator system is also incorporated (not shown) providing an additional audible warning system to notify the user of various alert conditions. The mode switch 124, alphanumeric display 120, indicator light display 122 and audible warning system (not shown) are connected with the UPS 100 through an interface control board 165, mounted in the chassis 130.

The UPS 100 is transportable, having a pair of handles 112 attached to the upper forward end of the chassis 130, a pair of small caster wheels 132 at the forward bottom end of the chassis 130 and a pair of larger wheels 134 at the rearward bottom end of the chassis 130. The only external connections are the input power cord 94 and the second power cord 92. The UPS 100 can therefore be easily moved from one location to another.

An openable cover 136 is provided at the top, providing access to the interior of the UPS 100, including the fuel cells and metal hydride canisters, as discussed in detail below. The openable cover 136 is preferably hinged to the chassis 130, but may be attached in alternative ways, including for example slidably connected or removably latched to the chassis 130.

Referring now to FIG. 2, an exploded view of the UPS 100 is shown without the cover 136. A fuel cell assembly 200 is provided for supplying electrical power when the external power source is not available. The fuel cell assembly 200 includes a plurality of fuel cells arranged in a stack 210, a hydrogen gas regulator 220 that controls the flow of hydrogen gas into the fuel cell stack 210, a compressor 230 including an air filter 235 that provides pressurized air to the fuel cell stack 210, a condenser 260 that condenses water vapor generated in the fuel cell stack 210, a fan 240 and cowling 245 for circulating unpressurized air externally over the fuel cells 210, and a control board 250.

In the preferred embodiment proton exchange membrane (PEM) fuel cells are used. Proton exchange membrane fuel cells have the advantages of operating at relatively low temperatures and pressures, and do not incorporate any significant hazardous materials.

The only byproducts from operation of fuel cell stack 210 with hydrogen are water and heat. The condenser 260 condenses the water vapor produced by the fuel cell stack 210. The condensed water is channeled to an evaporator 180, that wicks or otherwise absorbs the water. The fan 240 with cowling 245 provides a convective flow of air externally over the fuel cell stack 210 to help remove heat generated by the fuel cell stack 210. The air is ultimately expelled from the UPS 100 at least partially through the evaporator 180, thereby facilitating removal of water generated in the fuel cell stack 210.

The hydrogen gas regulator 220 controls the flow of hydrogen into the fuel cell stack 210. The control board 250 receives data from various sensors (not shown), for example stack temperature, air pressure, hydrogen pressure, purge cell voltage, and the like, and controls the supply of hydrogen and the cooling fan and compressor speed to optimize fuel cell performance and shuts down the system if necessary. The battery system 150 and power conditioning system 160 are also provided within the chassis 130. The battery system 150 includes a plurality of high capacity, high load rechargeable batteries 152 and a battery charging system (not shown). The battery system 150 serves three functions. First, if an external power outage occurs while the UPS mode switch is in the “POWERCELL” position, then the output power receptacle 110 will initially switch to the battery system 150 for power. The battery is connected through the power conditioning system 160 to the output power receptacle 110 to provide AC power, preferably within half a cycle (e.g. within approximately 8 milliseconds in a 60 Hz system). Initial power from the battery system 150 is necessary because the fuel cell assembly 200 requires a startup time, typically up to about one minute. Secondly, during start-up the fuel cell assembly 200 draws power from the battery system 150 to operate components such as the compressor 230 and to open the valves (discussed later) to circulate hydrogen gas to the fuel cell stack 210. Thirdly, even when the fuel cell assembly 200 is running at design power, the battery system 150 provides additional energy to accommodate surge power demands on the UPS 100, when the power demand exceeds the power generating capacity of the fuel cell stack 210. Surge power backup may be required, for example, during the start-up of electric motors or compressors.

The fuel cell assembly 200 produces DC electrical power, and of course the battery system 150, which may also provide power to the output power receptacle 110, also discharges DC electrical power. Therefore, to provide a high-quality AC power output at the output receptacle, the power conditioning system 160 includes a DC-DC converter, a DC-AC inverter, battery charge circuitry, load transfer circuitry and a microprocessor based control system (shown generically in FIG. 2 on the power conditioning system 160 board). Such systems are well known in the art. The DC-DC converter must interface with both the battery and the fuel cell to convert the operating DC voltage to the DC voltage required by the DC-AC inverter. In the preferred embodiment the DC-AC inverter transforms the DC power to sinusoidal AC power, although other inverters are contemplated by this invention, including, for example quasi-sine wave inverters. When the mode switch 124 is in the “POWERCELL” position, the control system senses the loss of grid power and switches to AC power derived from the battery system 150 preferably within one-half cycle of the 60 hertz wave form. When the fuel cell assembly 200 is operating, the control system switches to the fuel cell assembly 200 and initiates a battery recharge cycle if sufficient energy is available.

Again referring to FIG. 2, above the fuel cell assembly 200 a canister support structure 170 is provided. In the preferred embodiment the canister support structure 170 accommodates three metal hydride canisters 300, although more or fewer canisters are clearly contemplated by this invention. The canister support 170 includes a large central orifice 172 located generally above the fuel cell stack 210. Three canisters 300 containing metal hydride are supported in a horizontal position on the canister support 170.

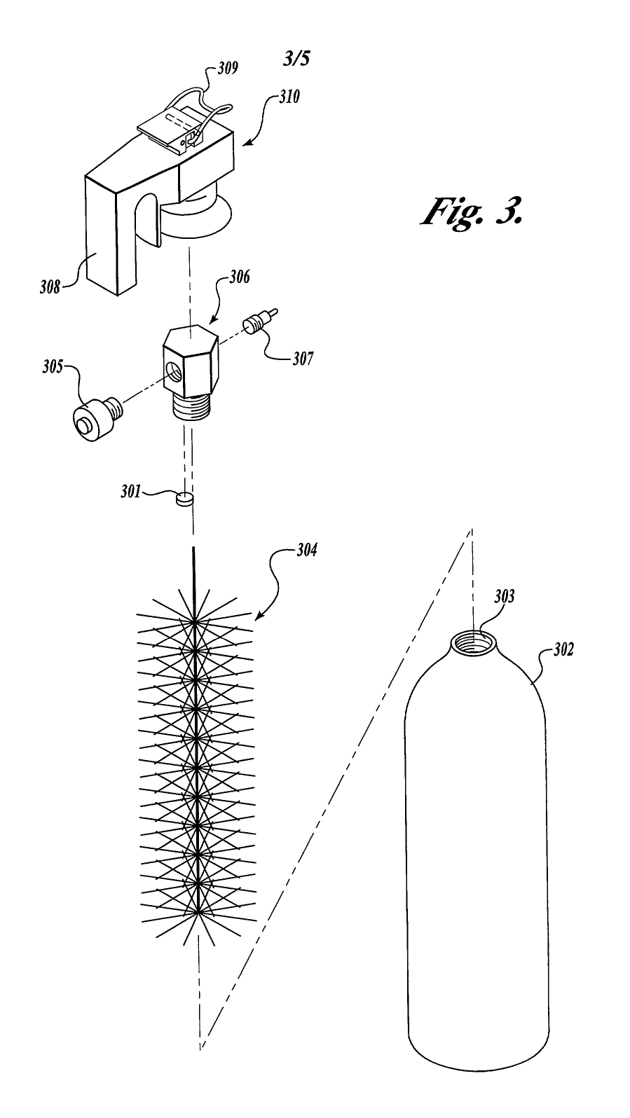

FIG. 3 shows an exploded view of a metal hydride canister 300. The metal hydride canister 300 includes a cylindrical bottle 302 having a threaded opening 303 at the top, a thermally conductive heat transfer element 304 that can be inserted through the opening 303 into the bottle 302, a threaded valve body 306 that engages the threaded opening 303, and a handle 310. In the preferred embodiment the heat transfer element 304 is a generally cylindrical, brush-like device made from a flexible, and thermally conductive material, preferably brass, but alternatively any other sufficiently conductive and flexible material including, for example, aluminum or copper. The heat transfer element 304 has a maximum diameter that is approximately equal to or greater than the inside diameter of the bottle 302. The flexible heat transfer element 304 will approximately retain its maximum diameter after being inserted into the bottle 302 through the smaller threaded opening 303. The bottle 302 is substantially filled with a granular and/or powdery metallic hydrogen storage alloy (not shown).

Hydrogen storage alloys are well known in the art, and have the ability to releasably absorb hydrogen, forming a metal hydride. The reaction of hydrogen with the metal alloy is reversible and is a function of pressure and temperature. The hydrogen storage alloy may be either of the AB2 type (primarily titanium and/or zirconium), or the AB5 type, (primarily rare earth/nickel alloys). A titanium-based AB2 type alloy is used in the preferred embodiment due to its more environmentally benign characteristics. Metal hydrides provide a superior reservoir of hydrogen, because the hydrogen density in metal hydrides can be significantly greater than for gaseous or liquid hydrogen, and the hydrogen can be stored at relatively low pressures and moderate temperatures. The reaction of hydrogen with the metal alloy can be written as a chemical reaction:

M+x/2H₂⇄MHₓ+Heat

where M represents the hydrogen storing metal alloy. The reaction is exothermic when hydrogen is absorbed forming the metal hydride, and endothermic when hydrogen is released. The rate of release of hydrogen from the metal alloy decreases with temperature. Therefore, the reaction is partially self-regulating. As hydrogen is released the metal alloy cools, reducing or even halting the rate of hydrogen release. However, to achieve the desired continuous power output from the UPS 100, sufficient heat must be provided to the metal hydride during operation to maintain the flow of hydrogen. Because the metal alloy is not a good thermal conductor, the heat transfer device 304 assists at keeping the metal alloy sufficiently warm during the operation of the UPS 100, by enhancing the heat flow into the metal hydride in the canister 300.

It will be appreciated now that the fan 240 (see FIG. 2) that circulates air over the fuel cell stack 210 directs the air flow upwardly, toward the metal hydride canisters 300. This air, heated by the exothermic reaction in the fuel cell stack 210, flows through the orifice 172 in the canister support 170, and provides the desired heating of the metal hydride canisters 300 during operation. The solid portions of the canister support 170 also provides a barrier that inhibits recirculation of the heated air back to the fuel cell assembly 200.

It will also be appreciated that by utilizing multiple metal hydride canisters 300, the amount of hydrogen required from any one canister 300 is reduced thereby limiting the amount of cooling in any canister 300. Multiple canisters 300 also facilitate the heat transfer into the metal hydride by providing a large surface area to volume ratio. Other means for improving heat transfer into the metal hydride are also contemplated. For example, the canisters may be provided with fins, heat pipes or similar devices to enhance heat transfer to the canister bottle. Alternatively, an auxiliary active heating system may be provided to heat the canisters, which active heating system may be powered directly from the fuel cell assembly.

A filter element 301 is provided at the base of the threaded valve body 306, to prevent any metal hydride from entering the valve body 306. The valve body 306 includes a shrader valve 307 to permit the controlled release of hydrogen from the canister 300, and a pressure relief valve 305. The handle assembly 310 slidably engages the valve body 306, to facilitate handling of the canister 300, with the grip portion 308 disposed opposite the shrader valve 307. A locking fastener 309 is disposed at the top of the handle 310 that is adapted to lock the canister 300 in place when the canister 300 is installed in the UPS 100, as discussed below.

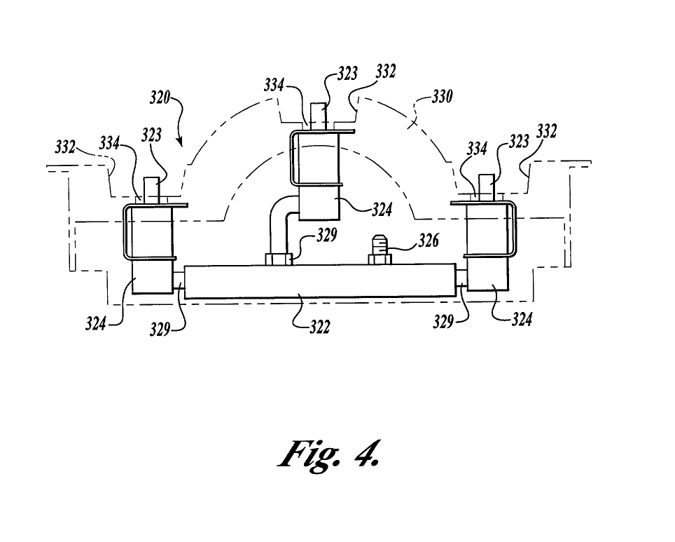

Referring again to FIG. 2, in the preferred embodiment three metal hydride canisters 300 are supported in a horizontal orientation by the canister support 170, directly above the fuel cell assembly 200. A manifold assembly 320 is located generally near the rearward end of the canister support 170, and includes a manifold 322 having three solenoid operated valve actuators 324, an outlet port 326 and a manifold cowling 330. An enlarged front view of the manifold assembly 320 is shown in FIG. 4, with the manifold cowling 330 shown in phantom. The manifold cowling 330 includes three inset portions 332 that are each designed to receive the handle end of a metal hydride canister 300. A slot 334 is provided in each inset portion 332 that engages the locking fastener 309 from the handle 310 of the metal hydride canister 300, to lock the canisters 300 in place. Each valve actuator 324 includes a cylindrical tube 323 extending upwardly to slidably engage the shrader valve 307 on its respective canister 300.

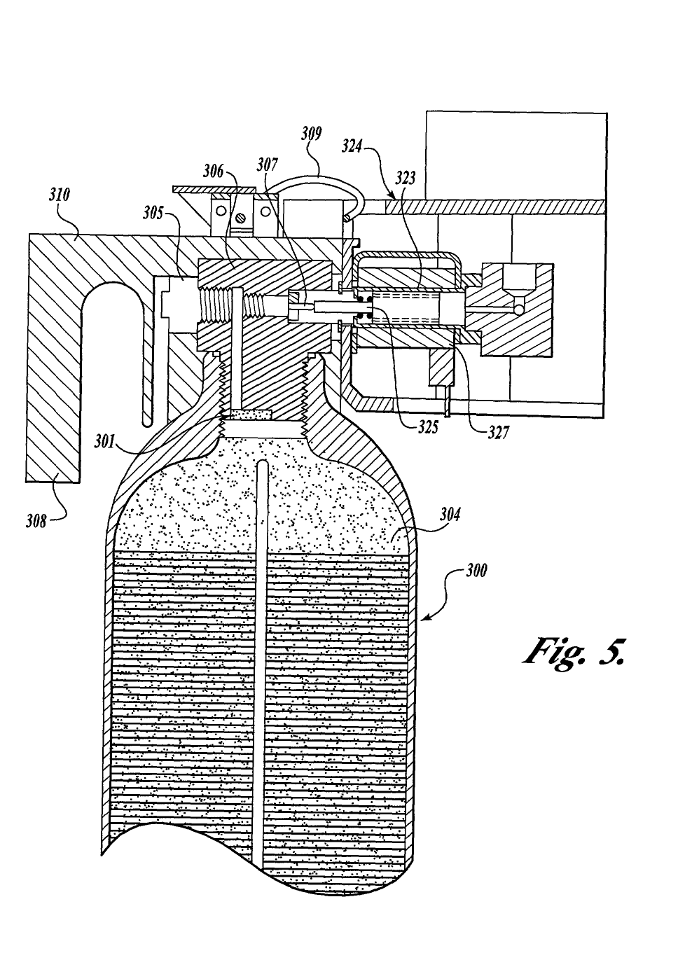

As seen most clearly in FIG. 5, which shows a cutaway view of the valve actuator 324 connected to a canister 300, a solenoid post 325 is slidably disposed in the cylindrical tube 323. A solenoid coil 327 encircles the post 325, such that activation of the coil 327 will cause the post 325 to push against the shrader valve 307, opening the valve. A flow path is provided past the post 325 and through the valve actuator 324, whereby the manifold 322 is in fluid communication with the canister 300 when the coil 327 is energized. This preferred configuration allows the shrader valves 307 to be selectively opened by energizing the appropriate solenoid coil(s) 327. As shown in FIG. 4, check valves 329 are included between the manifold 322 and each valve actuator 324. It will be appreciated that the shrader valves 307 on the metal hydride canisters 300 will automatically close if the canister 300 is disengaged from the manifold assembly 320, or if the coils 327 are de-energized for any reason. In addition, if a canister 300 is removed, the check valve 329 will prevent the outflow of hydrogen from the manifold assembly 320. Therefore, in the event that the fuel cell power production is interrupted for any reason, the shrader valves 307 will automatically close, stopping the outflow of hydrogen gas.

In operation, a high energy pulse of short duration is provided to the solenoid coils 327 on initial startup, to facilitate opening of the shrader valves 307. Once the valves 307 are open, the energy driving the solenoid coils 327 is reduced to conserve power to a level sufficient to maintain the valves 307 in the open position.

Another advantage of the system will be apparent to one of skill in the art. Because multiple metal hydride canisters 300 cooperatively supply the manifold 322 with hydrogen gas that is then plumbed to the hydrogen regulator 220, and check valves 329 are provided at the manifold connections, as well as the shrader valves 307 in the canisters 300, the canisters 300 may be separately removed and replaced while the UPS 100 is operating (i.e. hot swapped). By timely hot swapping of the canisters 300, the UPS 100 can provide power for an indefinite period of time.

Referring again to FIG. 4, an outlet port 326 is also fluidly connected to the manifold 322. The outlet port 326 provides a connection for attaching the manifold 322 to the hydrogen regulator 220. The hydrogen regulator 220, which is controlled by the control board 250 to the fuel cell assembly 200 controls the flow of hydrogen to the fuel cell assembly 200, maintaining the desired pressure.

The manifold cowling 330 (FIG. 2) includes a small tray that receives water from the fuel cell stack 210, and supports the evaporator 180. A plurality of vents 137 are provided whereby the air flow from the fan 240, over the fuel cell stack 210 (heat out) and past the metal hydride canisters 300 (heat in) then flows through the evaporator 180 and out of the UPS 100, thereby assisting in removing the water generated in the fuel cell stack 210.

In the preferred embodiment, the UPS 100 is capable of producing approximately one kilowatt of power for three hours without replacing any of the canisters 300. It will be apparent, however, that the disclosed invention is scalable to smaller or larger power outputs, and to longer run times. Greater maximum power output can be increased, for example, by simply increasing the number of fuel cells in the fuel cell stack 210, or incorporating multiple fuel cell stacks. Care must be taken, however, to ensure that the metal hydride temperature can be maintained high enough to permit the required hydrogen flow. Heat transfer to the canisters can be increased, for example by utilizing a larger number of canisters, thereby decreasing the amount of hydrogen required from any one canister 300, and increasing the total surface area for heat transfer. The power duration can also be increased by increasing the number of canisters 300, as well as by hot swapping canisters as discussed above.

In the preferred embodiment, the electric current generated by the fuel cell assembly 200 is monitored, and cumulatively tracked. The hydrogen reaction producing the current is well-behaved and predictable, therefore the current generated by the fuel cells is directly related to the amount of hydrogen consumed in the fuel cell assembly 200. The cumulative current generated is correlated to the hydrogen available in fully loaded metal hydride canisters 300, and a fuel-gage-type display is provided on the alphanumeric display 120 to provide the user with feedback regarding fuel usage. Although this is the preferred method of monitoring fuel availability, it will be apparent to one of skill in the art that other fuel monitoring methods could also be utilized, for example by using data from monitoring gas flow out of the canisters, or monitoring the canister pressure and temperature.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A mobile power generator comprising:
(a) a fuel cell assembly including a plurality of fuel cells, a compressor for providing pressurized air to the fuel cells, and a hydrogen gas regulator for regulating the flow of hydrogen to the fuel cells;
(b) at least one canister containing a metal hydride, the pressurized canister being connected through a canister valve to the hydrogen gas regulator to provide hydrogen to the fuel cell assembly;
(c) a rechargeable battery pack electrically connected to the fuel cell assembly;
(d) a chassis adapted to transportably support the fuel cell assembly, at least one canister, and the rechargeable battery pack;
(e) a power conditioning system including a DC to DC converter and a DC to AC inverter for receiving direct current from the fuel cell assembly and for supplying alternating current output;
(f) a power output receptacle for receiving alternating current output from the power conditioning system.

2. The portable power generator of claim 1 wherein the pressurized canister further comprises a generally cylindrical heat transfer device disposed within the canister, the heat transfer device having a plurality of thermally conductive bristles extending radially from the center of the canister.

3. The portable power generator of claim 2 further comprising a manifold assembly, and having at least three pressurized canisters, wherein the canisters are releasably connected to the manifold assembly, and the manifold assembly is connected to the hydrogen gas regulator.

4. The portable generator of claim 3 wherein the manifold assembly further comprises a plurality of electrically operated valve actuators for opening the canister valves.

5. The portable generator of claim 4 wherein each pressurized canister can be disconnected from the manifold without disconnecting the remaining pressurized canisters and without interrupting the power generation by the fuel cell assembly.

6. The portable generator of claim 5 wherein the canister valves are shrader valves that will automatically close if the canister is disconnected from the manifold.

7. The portable generator of claim 6 further comprising an air flow system that circulates air at least a portion of which flows over the fuel cell assembly and then over the canisters.

8. The portable generator of claim 6 wherein the air canisters are disposed horizontally above the fuel cell assembly.

9. The portable generator of claim 1 further comprising a means for monitoring the amount of hydrogen used, and an alphanumeric display indicating the amount of hydrogen available.

10. An uninterruptible power supply of the type having an input receptacle for receiving external alternating current and an output receptacle for outputting alternating current, the uninterruptible power supply comprising:
(a) a fuel cell stack capable of receiving air and hydrogen gas and generating direct current;
(b) an air compressor for providing pressurized air to the fuel cell stack;
(c) a hydrogen gas regulator having an input port and an output port, wherein the output port is connected to the fuel cell stack;
(d) a manifold assembly having a plurality of input ports and at least one output port wherein the output port is connected to the fuel cell stack;
(e) a plurality of canisters containing metal hydride, wherein each canister is releasably connected to a manifold input port whereby hydrogen released from the metal hydride may be channeled through the manifold and the hydrogen gas regulator to the fuel cell stack;
(f) a rechargeable battery system that is connected to the compressor for supplying operating current to the compressor;
(g) a power conditioning system having a DC to AC inverter for receiving direct current from the fuel cell stack and outputting alternating current to the output receptacle.

11. The uninterruptible power supply of claim 10 wherein the fuel cell stack comprises a plurality of proton exchange membrane type fuel cells.

12. The uninterruptible power supply of claim 11 wherein the fuel cell stack is capable of generating at least approximately 1 kilowatt of power.

13. The uninterruptible power supply of claim 10 wherein the power conditioning system is adapted to receiving direct current from the battery system whereby the power conditioning system will provide alternating current to the output receptacle while the fuel cell stack is powering up.

14. The uninterruptible power supply of claim 13, wherein the power conditioning system further comprises load transfer circuitry wherein the source of the energy provided to the output receptacle is switchable between the input receptacle, the battery system and the fuel cell stack.

15. The uninterruptible power supply of claim 10 wherein the plurality of canisters each include a valve and the manifold assembly having a plurality of valve actuators for opening and closing the canister valves.

16. The uninterruptible power supply of claim 15 wherein the canister valves are shrader type valves whereby the valve will automatically close when the canister is removed from the manifold.

17. The uninterruptible power supply of claim 16 wherein the manifold assembly further comprises a check valve disposed at each manifold input port such that removal of a canister will cause the associated manifold input port to close, whereby the plurality of canisters can be individually hot swapped while the fuel cell stack is operating.

18. The uninterruptible power supply of claim 10 further comprising a fan that directs air externally over the fuel cell stack to remove excess heat.

19. The uninterruptible power supply of claim 18 wherein the plurality of canisters are horizontally disposed above the fuel cell stack, and wherein at least a portion of the air heated by the fuel cell stack is directed towards the plurality of canisters thereby warming the canisters.

20. The uninterruptible power supply of claim 19 further comprising an evaporator that is adapted to receive water generated by the fuel cell stack, and wherein at least a portion of the air heated by the fuel cell stack flows through the evaporator.

21. The uninterruptible power supply of claim 10 wherein the canisters of metal hydride further comprise a thermally conductive heat transfer element disposed inside the canister.

22. The uninterruptible power supply of claim 21 wherein the thermally conductive heat transfer device comprises a generally cylindrical, brush-like device having flexible, radially extending bristles.

23. The uninterruptible power supply of claim 22 wherein the thermally conductive heat transfer device comprises a highly thermally conductive metal.

24. The uninterruptible power supply of claim 22 wherein the thermally conductive heat transfer device comprises brass.

25. The uninterruptible power supply of claim 10 further comprising a mobile chassis having a plurality of wheels whereby the uninterruptible power supply is readily movable from one location to another.

26. A canister for storing materials having poor thermal conductivity, the canister comprising a generally cylindrical bottle having a threaded aperture, a generally cylindrical heat transfer device insertable through the threaded aperture, the heat transfer device having a plurality of thermally conductive bristles that extend radially from the center of the bottle, and a threaded cap adapted to engage the threaded aperture thereby sealing the bottle.

27. The canister of claim 26 wherein the heat transfer device is made from a metal having good thermal conductivity characteristics.

28. The canister of claim 26 wherein the bristles of the heat transfer device are made from brass.

29. The canister of claim 26 wherein the cap further comprises a valve providing an openable fluid path to the interior of the bottle.

30. The canister of claim 26 wherein the bottle has a cylindrical outer wall having a circular cross section, and wherein the bristles of the heat transfer device extend generally from the center of the bottle to the outer wall.
